(19) United States
(12) Patent Application Publication
(10) Pub. No.: US 2026/0205924 A1
(43) Pub. Date: Jul. 16, 2026

(54) ROAMING DOWNLINK WINDOW OPERATIONS

(71) Applicant: APPLE INC., Cupertino, CA (US)

(72) Inventors: Pooya Monajemi, San Jose, CA (US); Oren Shani, Saratoga, CA (US); Anuj Batra, Redwood City, CA (US); Jarkko L. Kneckt, Los Gatos, CA (US); Chittabrata Ghosh, Fremont, CA (US); Yanjun Sun, San Diego, CA (US)

(21) Appl. No.: 19/416,766

(22) Filed: Dec. 11, 2025

Related U.S. Application Data
(60) Provisional application No. 63/743,710, filed on Jan. 10, 2025.

(51) Int. Cl. H04W 48/16

(52) U.S. Cl. CPC H04W 48/16

(57) ABSTRACT

Methods, systems, and apparatuses herein provide a handover enhancements for roaming from a source access point (AP) to a target AP. A STA may send a roaming initiation signal to the source AP to indicate a desire to move to a target AP. The STA may receive a roam ready message from the source AP. However, downlink data may have been leaked to the source AP prior to the route switch. The STA may retrieve buffered data from the source AP and new data from the target AP.

### TECHNICAL FIELD

This application relates generally to wireless communication systems, including contiguous sequence number operation for a Wi-Fi station during roaming.

### BACKGROUND

Wireless communication technology uses various standards and protocols to transmit data between an access point and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi^{®}).

In the 802.11 standard for WLAN, an access point (AP) is a device that creates a wireless local area network (WLAN), or Wi-Fi^{®} network. It may be connected to a wired network, such as an Ethernet network, and provides wireless access to that network for other devices. A station is a device that is capable of being wirelessly connected to the AP to join the WLAN network. Stations can be laptops, smartphones, tablets, or any other device with a WLAN adapter.

APs and stations communicate with each other using the Wi-Fi^{®} protocol. Various protocols have been established to increase security over a wireless communication network. For example, Simultaneous Authentication of Equals is the core authentication protocol of WPA3-Personal, and is mandated to be supported by all Wi-Fi^{®} Alliance certified devices, including both access points (APs) and non-AP stations (STAs).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example signaling diagram for a roaming procedure in accordance with some embodiments.

FIG. 2 illustrates an example contiguous sequence number (SN) operation across two APs in accordance with some embodiments.

FIG. 3 illustrates a block acknowledgement (BA) window motion operation for downlink during roaming in accordance with some embodiments.

FIG. 4 illustrates three example BA windows that have concurrent sequence numbers during a roaming procedure in accordance with some embodiments.

FIG. 5 illustrates an example BA window where the sequence number of AP1 overlaps with the pre-assigned AP2 sequence number space in accordance with some embodiments.

FIG. 6 illustrates an example BA window demonstrating that in some embodiments data associated with sequence numbers received from the target AP cannot be forwarded until older data is fully received.

FIG. 7A illustrates an example of a stuck TID problem in concurrent mode in accordance with some embodiments.

FIG. 7B illustrates an example of a stuck TID problem in sequential mode in accordance with some embodiments.

FIG. 8 illustrates an example of a STA-initiated window motion in accordance with some embodiments.

FIG. 9 illustrates an example AP-Managed Sequential roaming downlink in accordance with some embodiments.

FIG. 10 illustrates an example STA-Managed Sequential roaming downlink in accordance with some embodiments.

FIG. 11A illustrates an example BAR Control Field in accordance with some embodiments.

FIG. 11B illustrates an example embodiment where AP1 sends a BAR frame to a STA in accordance with some embodiments.

FIG. 12 illustrates a method for an STA, according to embodiments herein.

FIG. 13 illustrates a method for a source AP, according to embodiments herein.

FIG. 14 illustrates a method for a target AP, according to embodiments herein.

FIG. 15 illustrates an example system for performing signaling between a wireless device and a network device, according to embodiments disclosed herein.

### DETAILED DESCRIPTION

Wireless communication technology uses various standards and protocols to transmit data between an access point and a wireless communication device. One standard that is used for wireless communication is the Institute of Electrical and Electronics Engineers (IEEE) 802.11 standard for Wireless Local Area Networks (WLAN) (commonly known to industry groups as Wi-Fi^{®}). Wi-Fi^{®} provides a convenient way to establish a network between devices. A device (e.g., a station) may connect to a Wi-Fi^{®} access point to join a network and connect to the internet wirelessly.

An access point (AP) is a device that creates a wireless local area network (WLAN), or Wi-Fi^{®} network. A station (STA) is a device that is capable of being wirelessly connected to the AP to join the network. A mobile-AP is a device that can function as a portable AP to provide internet access to nearby STAs. For example, a mobile-AP may be a cellular phone with hotspot mode enabled.

Various embodiments are described with regard to a STA and AP. However, reference to a STA and AP is merely provided for illustrative purposes. The example embodiments may be utilized with any electronic component that may establish a connection to a network and is configured with the hardware, software, and/or firmware to exchange information and data with the network. Therefore, the STAs and APs as described herein are used to represent any appropriate electronic component.

Roaming occurs when a STA transitions its connection from one AP to another. Roaming may be used to provide uninterrupted connectivity as the STA moves or for better network performance. The roaming process may begin with the STA discovering potential target APs through scanning or using stored information. The STA may then evaluate factors like signal strength, network load, and quality of service requirements to select a target AP. Once the decision is made, the STA may initiate the roaming procedure to move its connection from the source AP to the target AP.

During the roaming process, some downlink data destined for the STA may be lost. This can happen when packets buffered at the source AP MLD are not delivered before the STA disconnects or when in-transit packets are dropped during the handoff. Additionally, delays in rerouting data to the target AP MLD may contribute to packet loss. To mitigate these issues, some embodiments herein introduce procedures to handle buffered downlink data on the source AP.

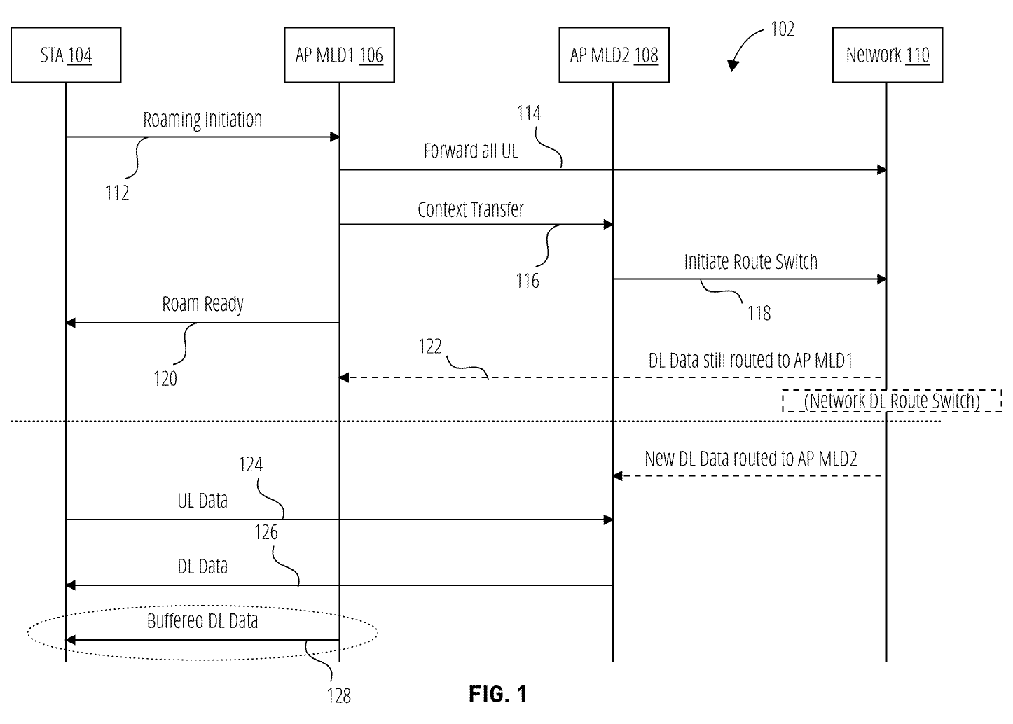

FIG. 1 illustrates an example signaling diagram 102 for a roaming procedure in accordance with some embodiments. Based on network conditions, the STA 104 may determine that a target AP (e.g., AP MLD2 108) may provide a better link than the current source AP (e.g., AP MLD1 106). The STA 104 may perform a roaming process to transition from the source AP to the target AP.

In the illustrated embodiment, the STA 104 performs a roaming procedure to move from AP MLD1 106 to AP MLD2 108. As shown, the STA 104 may send a roaming initiation 112 to the AP MLD1 106 which is the current AP (e.g., the origin of the roam). The STA 104 may then wait for a roam ready message 120 from AP MLD1 106 that indicates that the STA 104 may communicate with the target AP (e.g., AP MLD2 108).

While the STA 104 is waiting a number of network-side signaling occurs. The AP MLD1 106 may forward any uplink data 114 that is currently stored at the AP MLD1 106 to the network 110 (e.g., the distribution service (DS)). Further, there is a context transfer 116 between the AP MLD1 106 and the AP MLD2 108. The context transfer 116 may allow the AP MLD1 106 to transfer session-related information to the AP MLD2 108 to facilitate a seamless handoff.

The AP MLD2 108 sends the network 110 an initiate route switch message 118. The initiate route switch message 118 provides a notification to the network 110 that the route is going to be switched such that now the STA 104 will be communicated with AP MLD2 108, and any new downlink data should be forwarded to AP MLD2 108 instead of AP MLD1 106.

The AP MLD1 106 sends the roam ready message 120 to the STA 104. The STA 104 switches data path to the target AP MLD (e.g., AP MLD2 108) to send new uplink frames (e.g., uplink data 124) and receive new downlink frames (e.g., downlink data 126).

Meanwhile there may still be some downlink frames sitting on the origin AP MLD (AP MLD1 106). For example, there may have been a little lag in the network initiating the route switch. In that lag, some leaky downlink data 122 may have been sent to the AP MLD1 106.

In some embodiments, the STA 104 may be allowed to continue to retrieve these buffered downlink data frames 128 from AP MLD1 106. This process may assume no data transfer between AP MLDs is supported. In case of data transfer capability in network, the STA 104 may disable all links with AP MLD1 106 and retrieve both the buffered downlink as well as the new downlink from AP MLD2 108. Retrieval of the buffered downlink data frames 128 may provide a loss-less transition with minimal latency. Some embodiments herein provide procedures for retrieval of the buffered downlink data frames 128 from the source AP and handling downlink retrieval from the target AP.

In Wi-Fi, the sequence number (SN) space for downlink communication is a mechanism used to ensure the reliable delivery of data frames belonging to a certain Traffic Identifier (TID) from an AP to a STA. The AP assigns each data frame a unique sequence number within a sequence space, which allows the receiving STA to detect duplicate frames, identify missing frames, and reassemble fragmented frames correctly. In some embodiments, an operation may be implemented where AP1 and AP2 operate using bits on the same sequence number space on the same block ACK.

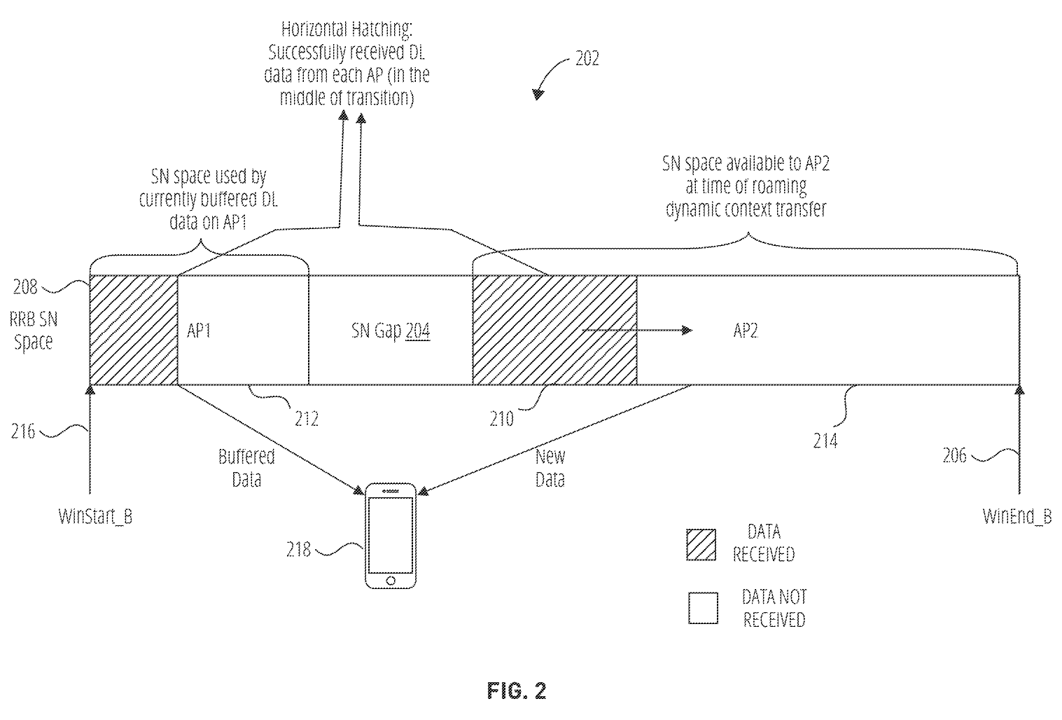

FIG. 2 illustrates an example contiguous sequence number (SN) operation across two APs in accordance with some embodiments. In some embodiments, downlink operation during roaming may use a common SN space, with potential to support concurrent downlink. In this mechanism, an SN gap 204 may be assigned by AP1 to allow for further downlink frames from the DS until DS mapping is updated.

For example, an STA 218 may receive downlink data from AP1 (e.g., received downlink data from AP1 208) and roam to AP2. Both AP1 and AP2 may use the same SN space. Accordingly, the downlink operation may not be completed on the AP1. Instead, the STA 218 may retrieve more data from AP2 (e.g., received downlink data from AP2 210, and new data 214) that follow the same sequence numbering as the data from AP1. Potentially the data from AP1 and AP2 are received at the same time (e.g., using two radios). The illustrated window 202 shows a reordered buffer of data received at the STA 218.

The STA 218 may receive downlink data from two APs during the roaming transition. The window 202 shown comprises a series of packets that increase in sequence numbers from WinStart_B 216 to WinEnd_B 206. For example, in some embodiments the window may be 1024 sequence numbers long. The sequences numbers are used in the two associations with AP1 and AP2. The received downlink data from AP1 208 and the received downlink data from AP2 210 have been received by the STA 218. There is also buffered data 212 that the AP1 has received and still has to send to the STA 218.

The window 202 also includes an SN gap 204. The SN gap 204 may be assigned when the STA 218 roams. When the STA roams, AP1 sends context to AP2, and the context may include information about this window 202 (e.g., the starting SN for AP2). At that point AP1 may have received some data on its own that it needs to send to the STA 218. Accordingly, AP1 may determine that it will use a certain number of sequence numbers (e.g., sequence numbers zero to 50 out of 1024). In the context, AP1 may inform AP2 to start from sequence number 200. This may leave an SN gap 204 of 150 sequence numbers. That gap may be implemented to accommodate any new data that the network may still send to AP1 (e.g., leaky downlink data 122 of FIG. 1). This additional data may be sent to AP1 because the network has a lag in updating the mapping to AP2. Until the mapping is complete there may be some data that leaks from the network to AP1. Accordingly in some embodiments, when AP1 is sending this context transfer to AP2, AP1 may request that AP2 start from a sequence number with some gap (e.g., an SN gap 204) assigned to accommodate assigning a sequence number to the leaky data.

During the transition period of a roaming operation, the window may move forward due to AP1 transmissions, and AP2 may not have the latest updated window information. Any downlink MAC Protocol Data Unit (MPDU)s received by AP2 with SN greater than WinEnd_B 206 can be buffered until window moves forward.

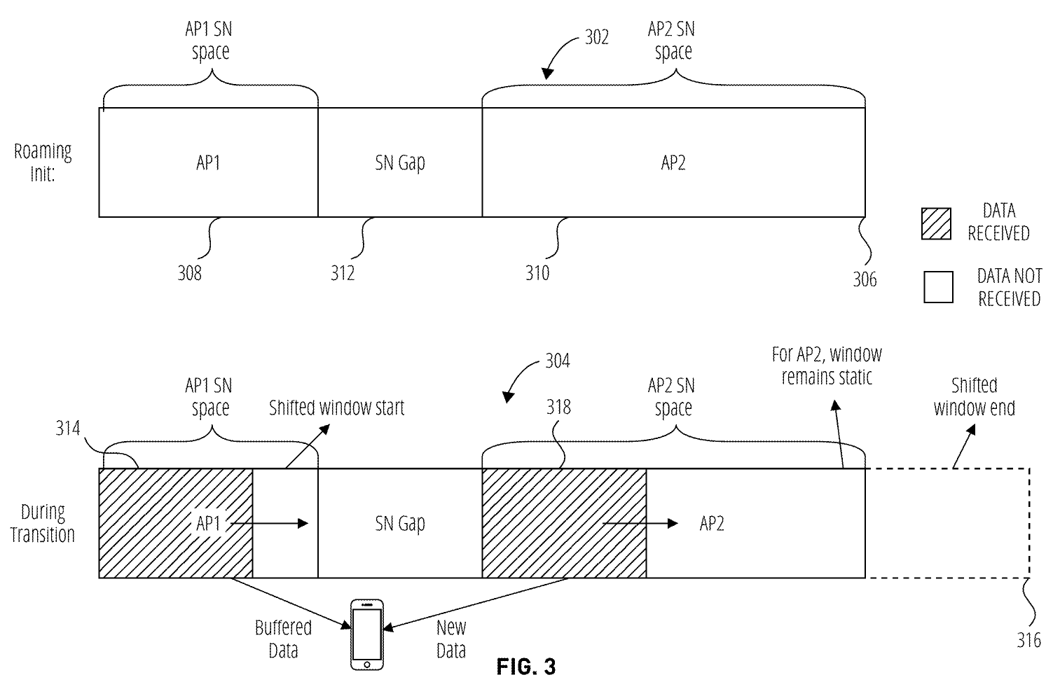

FIG. 3 illustrates a block acknowledgement (BA) window motion operation for downlink during roaming in accordance with some embodiments. The BA window motion refers to the mechanism in Wi-Fi networks that manages the tracking of successfully received frames in a BA session. It involves dynamically adjusting the acknowledgment window to accommodate newly received frames. As downlink frames are transmitted by an AP and successfully received by the STA the BA window may shift. However, there may be a problem with the window motion during roaming.

As shown, the window at roaming initiation 302 may have an initial window end 306. A first number of sequence numbers 308 may be assigned to AP1, an SN gap 312 may be defined, and a second number of sequence numbers 310 may be assigned to AP2. As downlink frames are transmitted by AP1, the BA window should shift per baseline. For example, the window during transition 304 shows AP1 transmitted frames 314, based on those frames the window during transition 304 may shift to the shifted window end 316. For example, if AP1 transmitted frames 314 includes 100 frames and the overall window size is 1024 sequence numbers, the shifted window end 316 may be at sequence number 1124.

However, there are a number of problems associated with shifting the window during transition 304. This new window information does not get updated at AP2, at least not immediately. So as the frames from AP1 are successfully transmitted and received, AP1 may know that the window can shift, but AP2 may not know of the window shifting. AP2 remains on the BA window that was synchronized at the time of roam initiation (e.g., the window at roaming initiation 302). There may not be a need to update the window after each downlink transmission by AP1, but the window may be updated at least once when all AP1 buffers are empty.

The window should not be moved to after the SN gap 312 because of AP2 downlink transmissions 318 during the transition period. For example, a Block Acknowledgment Request (BAR) from AP2 should not move the STA’s window when transition is happening. If the window moved due to the AP2 downlink transmissions 318 it may result in the remaining packets from the AP1 appearing outside of the window.

Some embodiments herein provide solutions to the BA window motion problem outlined with reference to FIG. 3.

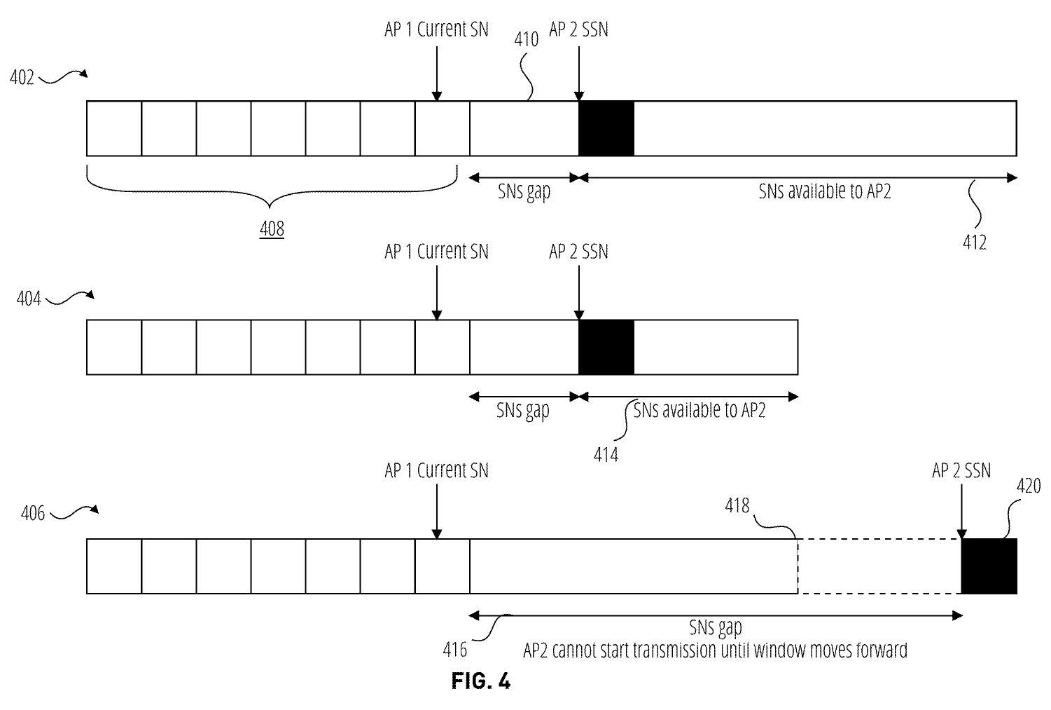

A system using concurrent sequence numbers for downlink during a roaming procedure also faces a sequence number space problem. In some embodiments, the window size may present an issue for maintaining a concurrent sequence during roaming. FIG. 4 illustrates three example BA windows that have concurrent sequence numbers during a roaming procedure in accordance with some embodiments.

The first BA window 402 is a large window where the first sequence number for AP2 is near the middle of the window. As shown in the first BA window 402, when the window is sufficiently large and the AP2 is left with sufficient sequence numbers, there may not be an issue with concurrent sequence numbers. As shown, the sequence numbers 408 used by the AP1 and the sequence gap 410 may end near the middle of the overall window. This may leave sufficient sequence numbers 412 available to AP2.

However, some windows may have a different size. Smaller windows may cause issues with concurrency. In some embodiments, concurrency may only occur if we can have a large enough window to handle potential downlink transmissions before DS mapping update. For example, the second BA window 404 is much smaller and leaves fewer sequence numbers 414 available to AP2.

Further, there may be a cost of implementing larger RRB windows. With a smaller BA window, a burst of downlink frames during the roam can overrun the Starting Sequence Number (SSN) assigned to AP2 during dynamic context transfer. For instance, in the third BA window 406 the SN gap 416 extends beyond the end of the window 418. This results in the SSN 420 assigned to AP2 occurring after the window.

Some embodiments herein provide solutions to the sequence space problem outlined with reference to FIG. 4.

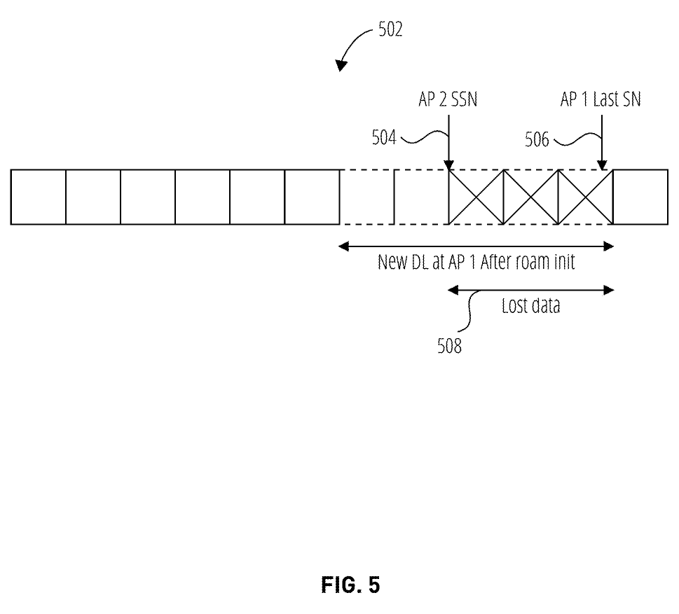

A system using concurrent sequence numbers for downlink during a roaming procedure also faces a sequence number overlap problem. Arrival of too many downlink frames from the DS can cause the AP1 sequence number space to run out and overlap with the pre-assigned AP2 sequence number space. This will cause loss of downlink data. Assignment of AP2 SSN values is out of the control of the STA. In the case of a smaller window, forcing concurrent operation may increase the likelihood of sequence number overlap and downlink loss. FIG. 5 illustrates an example BA window 502 where the sequence number of AP1 overlaps with the pre-assigned AP2 sequence number space in accordance with some embodiments.

A SN gap may be assigned to handle any incoming downlink that is leaked from the network. However, in the illustrated embodiment, the SN gap is not large enough resulting in data from AP1 overlapping sequence numbers with the data from AP2. As shown, the AP 2 SSN 504 occurs before the AP 1 last sequence number 506 resulting in duplicate sequence numbers being used for data from AP1 and AP2. The overlapping sequence numbers may result in lost data 508.

Some embodiments herein provide solutions to the sequence number overlap problem outlined with reference to FIG. 5.

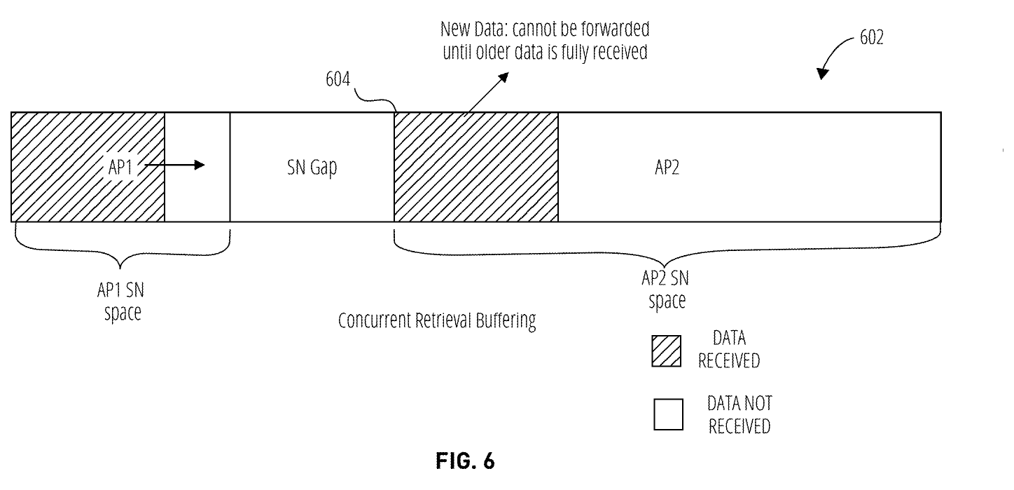

In some embodiments sequential retrieval may be used. FIG. 6 illustrates an example BA window 602 demonstrating that data associated with sequence numbers received from the target AP cannot be forwarded until older data is fully received. Sequential downlink retrieval refers to first emptying the AP1 buffer (source AP buffer), then starting new downlink from AP2 (target AP). In other words, new downlink data 604 from AP2 is not forwarded until older data is fully received.

There are several reasons for choosing sequential downlink retrieval. For example, new downlink data 604 from AP2 cannot be forwarded to the stack in order until older data on AP1 is received first resulting in little gain in receiving new data earlier. Further, when the AP1 link is fading, avoiding downlink loss may mean prioritizing the reception of buffered downlink frames from AP1 before receiving new downlink frames from AP2 (no data transfer between APs assumed). Placing radio resources on AP2 link takes away from chances for AP1 to complete this transmission as quickly as possible. Also, a smaller BA window size can leave a very limited or no space of sequence numbers for the target AP. Sequence number overlap can be handled in sequential operation but not in concurrent mode. That is, the STA may be able to handle receiving new data from AP2 with a starting sequence number that is smaller than the last sequence number received form AP1, as long as all data from AP1 is received and processed first before receiving new data from AP2.

In this mode, STA can receive a notification of AP1 buffer status in order to forward downlink to stack and go out of power management mode in AP2 link.

For example, in some embodiments, the STA may have one link with AP1 and another link with AP2. When the STA roams from AP1 to STA, the STA may first receive buffered downlink data from AP1, and then send a signal (e.g., a message with PM=1) to notify AP2 that it is ready to receive data. In this way, the STA may retrieve data sequentially.

Systems that use contiguous sequence numbers during roaming transitions may also face a stuck Traffic Identifier (TID) problem. The stuck TID problem refers to a situation where data for one TID cannot advance until data for all other TIDs is fully received. This may result in latency. The problem can occur if there is only one notification of buffer empty from the origin AP.

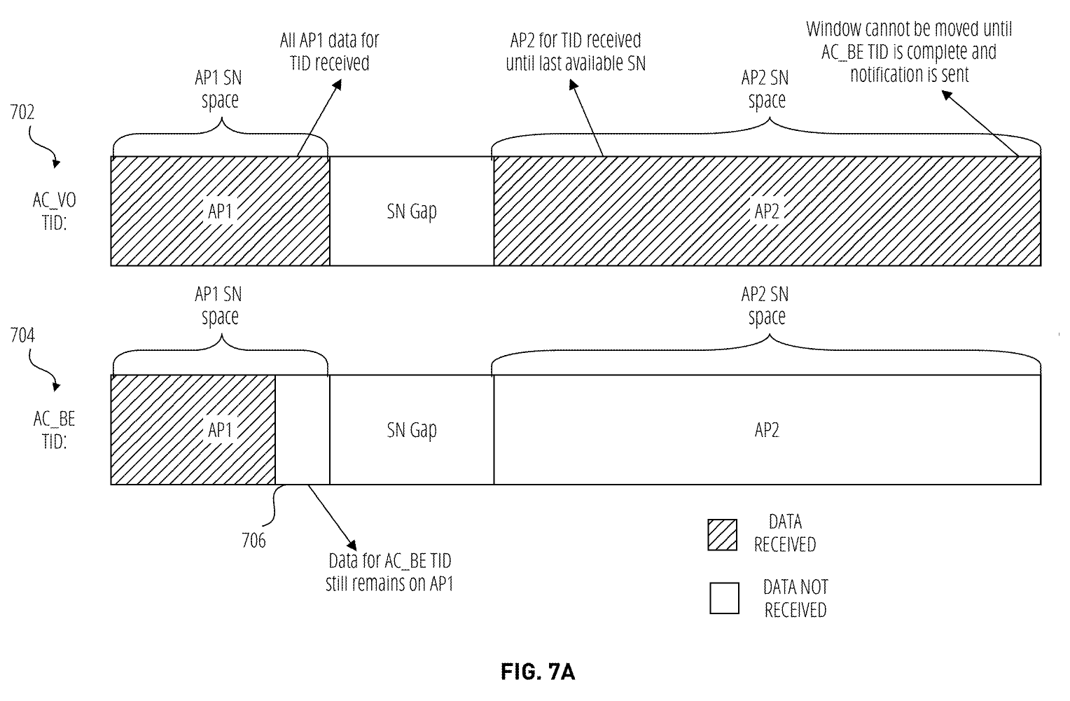

FIG. 7A illustrates an example of a stuck TID problem in concurrent mode (e.g., data may be received from both AP1 and AP2 during roaming) in accordance with some embodiments. In concurrent mode, the STA may receive enough data from both APs to fill the window for one TID, but the window cannot move forward until the STA receives a notification that the data from AP1 for other TIDs is complete.

In the illustrated embodiment, there is data associated with two TIDS. Data may be associated with multiple different TIDs mapped to different Access Categories including voice (AC_VO), video, best effort (AC_BE), and background. In the illustrated embodiment, the STA is receiving AC_VO data 702 and AC_BE data 704. A problem may occur when reception of data associated with one of the TIDs stalls and the STA is still trying to receive data for data associated with other TIDs.

For example, the STA may be receiving AC_VO data 702 and AC_BE data 704 at the same time. In the illustrated embodiment, the window for AC_VO data 702 is filled up, but there is a lot of AC_BE data 704 still to be received. Now, in order to receive the next AC_VO data 702, the STA may wait for AP1 to send a signal (e.g., to AP2) that the buffered data on AP1 has been sent. This indication may allow the window for the AC_VO data 702 to move forward. However, if the AP1 only sends one notification when the buffer is empty of all data regardless of TID, the STA may not receive additional AC_VO data 702 until the remaining data 706 for AC_BE TID is sent from AP1.

This problem can also occur in sequential mode. FIG. 7B illustrates an example of a stuck TID problem in sequential mode in accordance with some embodiments. In sequential mode, the STA waits to empty all AP1 buffer before receiving data from AP2. Accordingly, AC_VO data 708 cannot advance until AC_BE data 710 is also complete when the AP1 only sends one notification that the buffer is empty. Data associated with both TIDs must be sent from the AP1 before data from AP2 can be received in such embodiments.

Some embodiments may use a per-TID sequential operation. A per-TID sequential operation may solve the stuck TID problem. For each TID, data may be received from the origin AP first before receiving new data from the target AP for the same TID. For example, a STA may begin receiving more AC_VO data from the target AP after the AC_VO data on AP1 is sent regardless of the state of the AC-BE data. In some embodiments, concurrency of downlink reception can occur for data of different TIDs.

In some embodiments the source AP (e.g., AP1) may send an indication to the target AP (e.g., AP2) that the buffer data on AP1 is delivered, and that AP2 may begin transmitting and the window motion may be initiated. However, it may be desirable for a STA to initiate AP2 transmissions. Accordingly, in some embodiments, the STA may indicate to the target AP that the STA wants to begin receiving data, and potentially move the window forward. This can be also applied to cases where contiguous SN spaces are not used, and the window is reset on AP2.

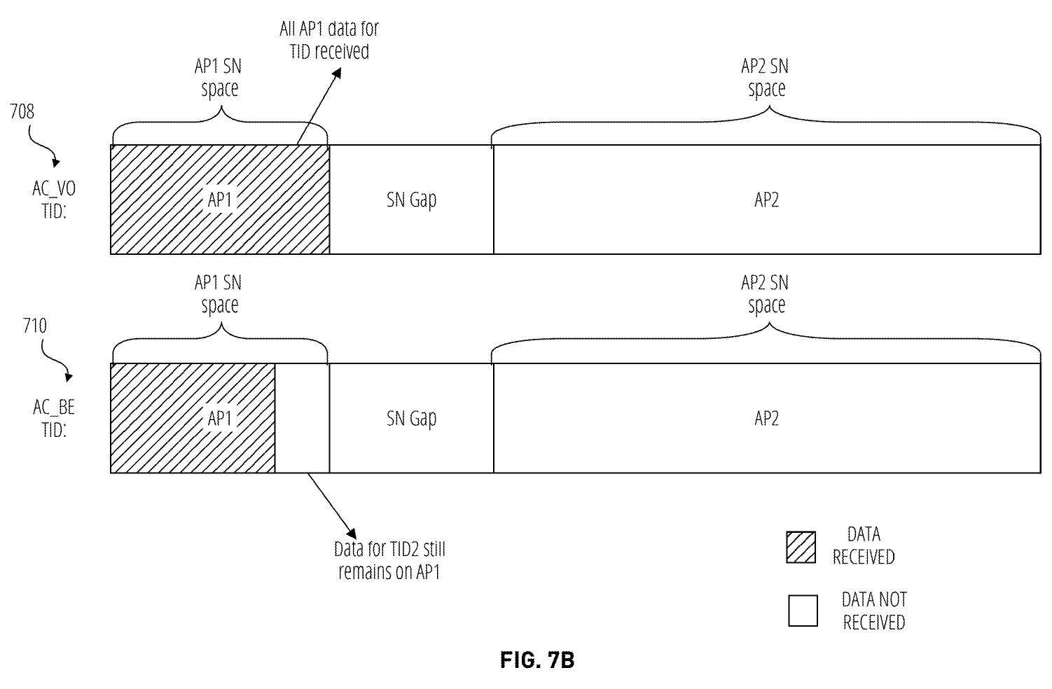

For instance, FIG. 8 illustrates an example of a STA-initiated window motion in accordance with some embodiments. In some embodiments, the STA 802 may be able to indicate to the AP2 that STA 802 wants to move the window forward to after the AP1+Gap SN, in order to receive more downlink. For instance, the STA 802 may be receiving data 804 from AP1 and then desire to obtain data 806 from AP2. The window may be moved forward based on that indication from the current RRB 808 filled up to the last SN in the original BA window at the time of roam to include the new AP2 data 810 pending window shift.

One use case for a STA-initiated window motion includes when the link with the first AP may be disappearing very quickly, or already lost (as illustrated). For example, the STA 802 may determine that it is losing or has lost the link to AP1. If the link is completely gone, the STA 802 should not be stuck waiting to receive everything from AP1. To prevent being stuck waiting for data from AP1, the STA 802 may be able to send a signal to AP2 indicating that AP2 should start sending data.

A second use case for a STA-initiated window motion includes when the STA 802 has no interest in receiving the buffered downlink on the AP1. Instead, the STA 802 may prefer to receive newer downlink data from AP2. For example, if the application protocol can handle some loss, latency may be improved by switching over to AP2 sooner rather than waiting for all the buffered data from AP1.

A third use case for a STA-initiated window motion includes when data for one TID is latency sensitive and STA wants to move to AP2 as soon as possible, before all other TIDs (or older downlink of the same TID) are received from AP1.

Accordingly, some embodiments may allow the STA to signal AP2 to cause AP2 to begin sending data and initiate window motion.

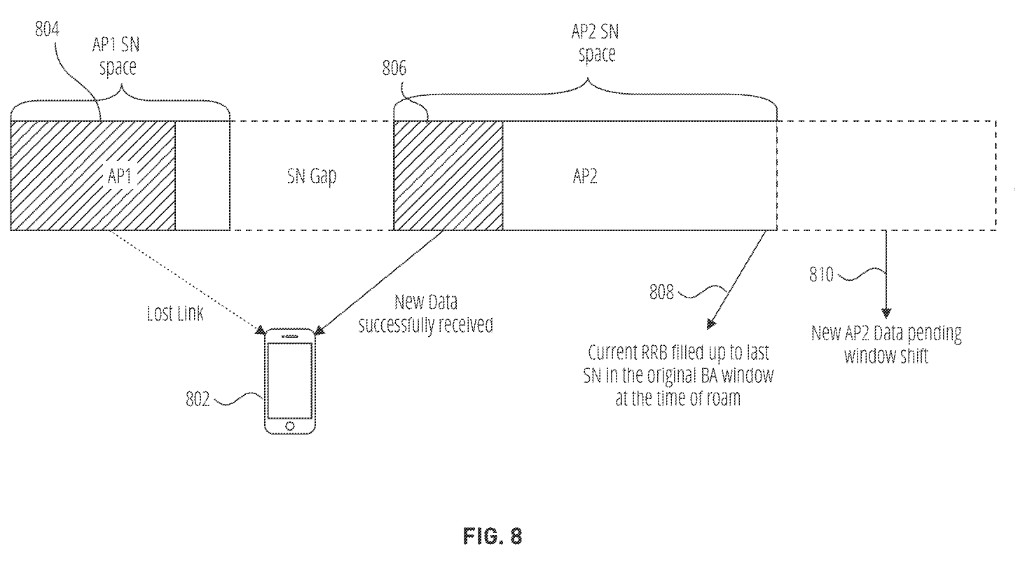

FIG. 9 illustrates an example AP-Managed Sequential roaming downlink in accordance with some embodiments. In some embodiments, the STA 904 maintains an active link with each AP after roam exchange. Since all uplink has to be transmitted to AP2 906, this may many times be the case. In the illustrated embodiment, AP1 902 informs AP2 906 when the buffered downlink data for a TID is delivered, and AP2 906 signals completion of the downlink data for the TID to the STA 904. This may allow additional data associated with one TID to be sent by AP2 906 while buffered data associated with other TIDs is still being sent by AP1 902.

At the time of initiating the roam, the STA 904 may request a per TID sequential operation. The per TID sequential operation means that as the AP1 902 is transmitting its data, whenever any data for any TID is done, AP1 902 will notify AP2 906 that data for the TID is done, and AP2 906 may use a frame to move the window forward and signal completion of downlink for the TID on AP1 902.

For example, in the illustrated embodiment, downlink data 908 associated with TID1 is sent by AP1 902 to the STA 904. In response, the STA 904 may send a block acknowledgement (BA) 910 to AP1 902. AP1 902 may signal (e.g., signal 912) to AP2 906 the completion of buffered downlink delivery for TID1.

AP2 906 may send a frame to the STA 904 to inform the STA 904 of the completion of the transmission of the downlink data 908 associated with TID1. In the illustrated embodiment, AP2 906 uses a BAR frame 914 to move window forward and signal completion of downlink for TID1 on AP1 902. In response, the STA 904 may send a BA 916 to AP2 906. AP2 906 may start sending TID1 traffic 918. AP1 902 may continue to send downlink data for other TIDs (e.g., downlink data 920 for TID2). A similar signaling process may be used to signal when buffered data transmission associated with the other TIDs (e.g., TID2) from AP1 902is completed.

In some embodiments, AP2 906 does not transmit downlink data for a TID until AP1 902 has no further buffered downlink data for that TID. The APs may synchronize the buffer status in the background (no STA involvement). For example, in the illustrated embodiment, AP1 902 signals to AP2 906 the completion of buffered downlink delivery for a TID.

In some embodiments, when AP2 906 receives a notification of completion of data for a TID from AP1 902, AP2 906 can send new downlink belonging to this TID to the STA 904. In some embodiments, when AP2 906 receives a notification of completion of data for a TID from AP1 902, AP2 906 can use the BAR frame 914. Both sending new downlink and sending the BAR frame 914 may inform the STA 904 that all data from the old AP for this TID is complete and move the window forward. Accordingly in some embodiments, the BAR frame 914 is used to explicitly indicate completion of data transfer associated with a TID, while in other embodiments the completion is implicitly indicated by the new data for the TID sent by AP2 906. In some embodiments, signaling the completion can be done by announcing AP2 SSNs to the STA 904 at the time of roam initiation, or by using explicit signaling in the BAR frame 914 (e.g., assigning one of the reserved bits).

In some embodiments, notifications for completed TIDs may be aggregated. For example, AP1 902 may signal to AP2 906 the completion of buffered downlink delivery for multiple TIDs at once. Similarly, AP2 906 may send one frame to the STA 904 to indicate completion of buffered downlink delivery for multiple TIDs at once.

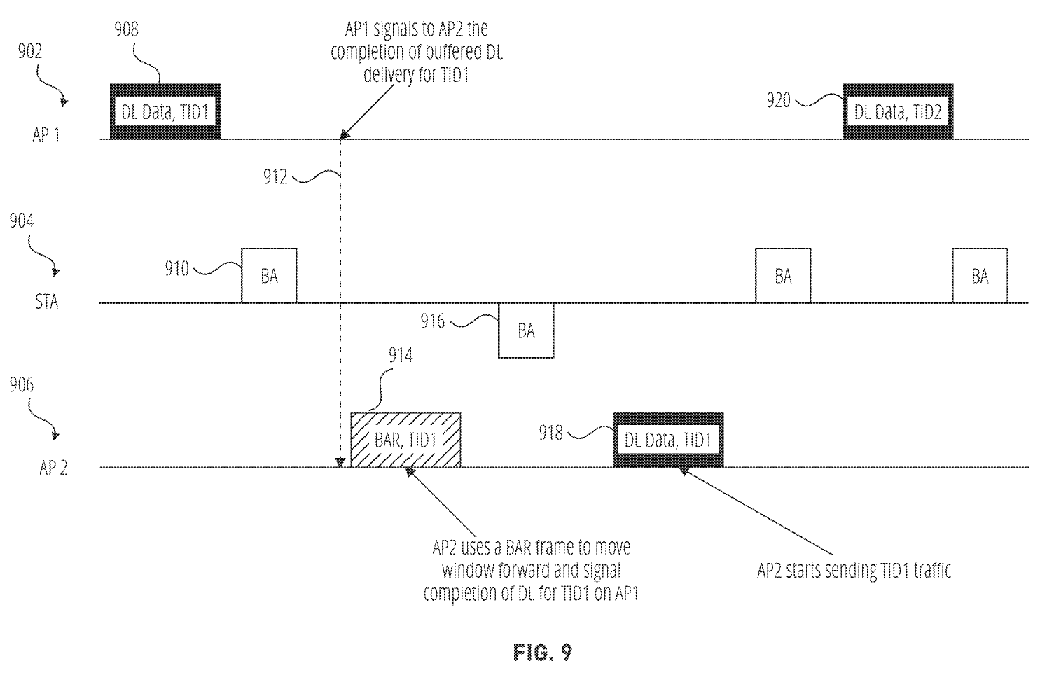

FIG. 10 illustrates an example STA-Managed Sequential roaming downlink, in accordance with some embodiments. In some embodiments, at the time of initiating the roam, the STA 1002 requests AP2 1004 to wait for STA 1002 explicit signal to transmit each TID.

In some embodiments, AP2 1004 does not transmit downlink data for a TID until STA 1002 explicitly requests continuation of downlink data for that TID. A frame from the STA 1002 can request AP2 1004 to move the window forward and continue transmission. The frame may be a new frame or an enhanced existing frame. In some embodiments, this frame can be applied per TID, an aggregation of multiple TIDs, or for all TIDs at the same time. The STA 1002 may choose to move the window forward to AP2 1004 quickly (and discard AP1 data), or wait for a notification from AP1 1006 that data is drained (as shown in FIG. 10). In some embodiments, the STA 1002 may receive notification of completion of data on AP1 side for each TID.

In the illustrated example embodiment, downlink data 1008 associated with TID1 is sent by AP1 1006 to the STA 1002. In response, the STA 1002 may send a BA 1010 to AP1 1006. AP1 1006 may signal via a frame (e.g., a BAR frame 1012) to the STA 1002 the completion of buffered downlink delivery for TID1.

The STA 1002 may send a BA 1014 to AP1 1006 to indicate the BAR frame 1012 was received. The STA 1002 may send a frame 1016 to AP2 1004 to request AP2 1004 to move the window forward and continue transmission. In some embodiments, the frame 1016 may be a new frame or an enhanced existing frame (e.g., an unsolicited BA frame). AP2 1004 may send an ACK 1018 and a BAR frame 1020 to the STA 1002. The AP2 1004 may start sending TID1 traffic 1022. AP1 1006 may continue to send downlink data for other TIDs (e.g., downlink data 1024 for TID2). A similar signaling process may be used to signal when buffered data transmission associated with the other TIDs (e.g., TID2) from AP1 1006 is completed.

In some embodiments, notifications for completed TIDs may be aggregated. For example, AP1 1006 may signal to STA 1002 the completion of buffered downlink delivery for multiple TIDs at once. Similarly, the STA 1002 may send one frame to the AP2 1004 to indicate that the AP2 1004 should begin transmitting downlink for multiple TIDs at once.

Note that such embodiments can be useful if STA 1002 wants to push the window forward and/or loses link with AP1 1006. For example, in some embodiments, the STA 1002 can choose to move the window forward to AP2 1004 without waiting for a notification form AP1 1006. A lost connection may therefore not result in a stuck TID. For example, the STA 1002 may monitor channel conditions, and based on a threshold (e.g., an RSSI, number of missed beacons, number of missed ACKs, etc.), decide to begin receiving data from AP2 1004.

Such embodiments may also assume no further coordination between APs about the AP1 buffer state. Note that embodiments (including those shown in FIG. 9 and FIG. 10) may be both used by a STA based on the networking condition.

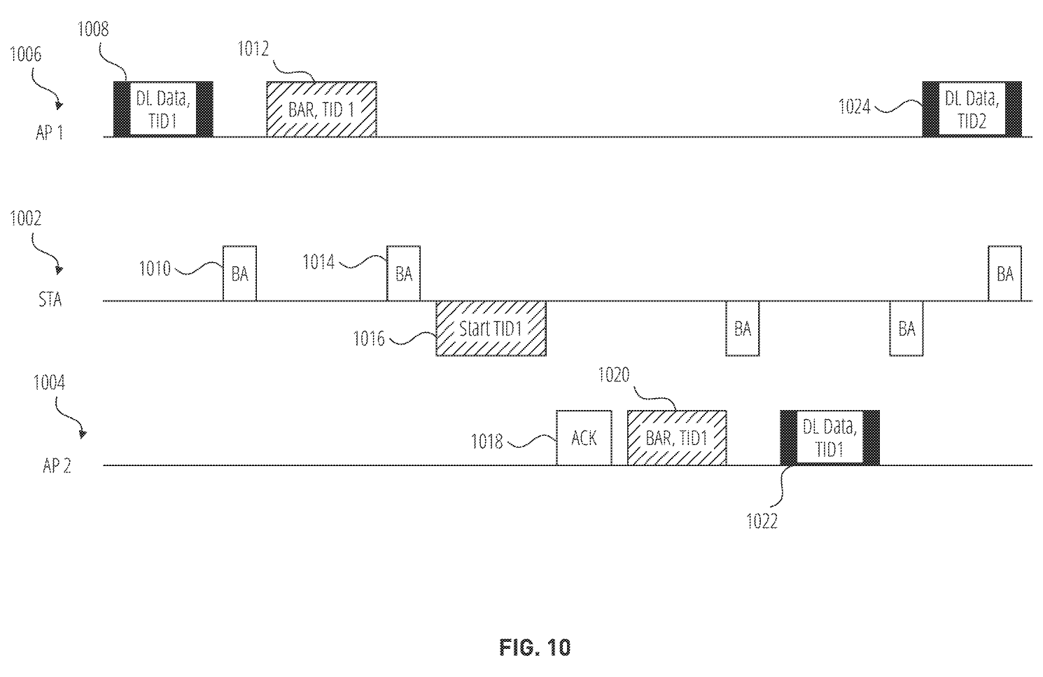

FIG. 11A illustrates an example BAR Control Field 1102 in accordance with some embodiments. The BAR Control Field 1102 may be used by a STA to indicate buffered data associated with one or more TIDs has been sent. For example, the source AP (e.g., AP1) may send a BAR frame for each TID that has a BA session associated and whose downlink buffers are empty. The BAR frame can include the BAR Control Field 1102. The BAR Control Field 1102 can use an end of TID data field 1104 to signal the empty buffer during roaming transition.

This BAR frame from AP1 may be used to indicate not to move the BA window forward at the STA side. This way AP2 may be responsible to move the BA window over the SN gap. A Multi-TID BAR frame can be used to announce completion for more than one TID.

FIG. 11B illustrates an example embodiment where AP1 sends a BAR frame 1106 to a STA 1108 in accordance with some embodiments. As shown, the AP1 may send the BAR frame 1106 to a STA 1108 to indicate the buffers associated with one or more TIDs are empty. The AP2 may move the BA window over the SN gap to the SSN 1110.

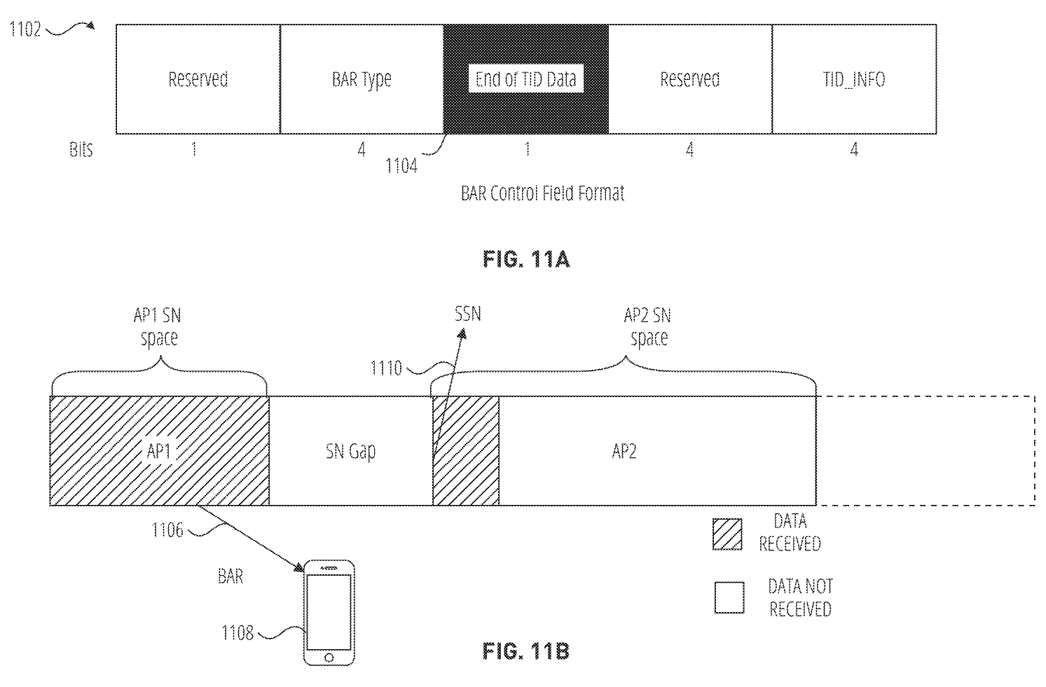

FIG. 12 illustrates a method 1200 for an STA, according to embodiments herein. The illustrated method 1200 includes sending 1202 a roaming initiation signal to a source AP to indicate to the source AP a desire to move to a target AP. The method 1200 further includes receiving 1204 a roam ready message from the source AP. The method 1200 further includes retrieving 1206 buffered data from the source AP after the roam ready message is received. The method 1200 further includes requesting 1208 the target AP to begin transmitting new data for at least one TID. The method 1200 further includes receiving 1210 the new data from the target AP.

In some embodiments of the method 1200, the buffered data from the source AP and the new data from the target AP are received concurrently.

In some embodiments of the method 1200, the new data from the target AP is sent after the buffered data of the source AP is retrieved. In some such embodiments, the new data is not sent until data corresponding to all the TIDs are retrieved from the buffered data.

In some embodiments of the method 1200, the buffered data from the source AP and the new data from the target AP are sequentially retrieved using a common sequence number space, wherein sequence number overlap is accounted for during sequential retrieval.

In some embodiments of the method 1200, the buffered data from the source AP and the new data from the target AP use non-contiguous sequence number spaces.

In some embodiments, the method 1200 further comprises receiving an indication from the target AP when the source AP has no further buffered downlink data for a specific TID.

In some embodiments, the method 1200 further comprises sending to the source AP a request for a per TID sequential operation, maintaining an active link with both the source AP and the target AP after receiving the roam ready message, and receiving a frame from the target AP indicating to move a window of the common sequence number space forward, and wherein the frame signals completion of downlink for a specific TID on the source AP. In some such embodiments, the frame from the target AP is a BAR frame. In some other such embodiments, the frame comprises downlink data belonging to the specific TID.

In some embodiments, the method 1200 further comprises requesting that the target AP wait for an explicit signal from the STA to transmit data associated with each of the TIDs, and sending the explicit signal to the target AP to request that the target AP move a window of the common sequence number space forward and transmit the new data. Some such embodiments further comprise receiving a notification of completion of data from the source AP for each of the TIDs. In some other such embodiments, the explicit signal is sent in response to a link with the source AP being lost.

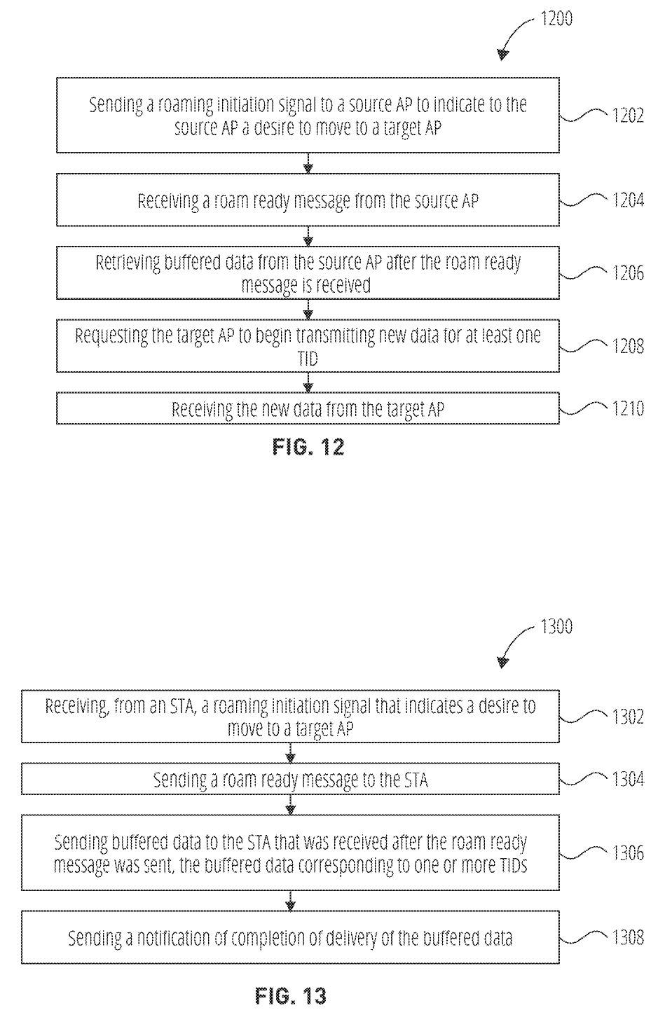

FIG. 13 illustrates a method 1300 for a source AP, according to embodiments herein. The illustrated method 1300 includes receiving 1302, from an STA, a roaming initiation signal that indicates a desire to move to a target AP. The method 1300 further includes sending 1304 a roam ready message to the STA. The method 1300 further includes sending 1306 buffered data to the STA that was received after the roam ready message was sent, the buffered data corresponding to one or more TIDs. The method 1300 further includes sending 1308 a notification of completion of delivery of the buffered data.

In some embodiments of the method 1300, the notification of completion of delivery of the buffered data is indicates data associated with a first TID of the one or more TIDs was sent. Some such embodiments further comprise continuing to send buffered data associated with other TIDs after the notification is sent. In some other such embodiments, additional notifications of completion are sent for other TIDs as deliveries for the other TIDs are completed.

In some embodiments of the method 1300, the notification of completion of delivery of the buffered data is sent when the buffered data associated with all of the one or more TIDs are sent.

In some embodiments of the method 1300, the notification of completion is sent to the target AP.

In some embodiments, the method 1300 further comprises receiving, from the STA, a request for a per TID sequential operation.

In some embodiments of the method 1300, the notification of completion is sent to the STA.

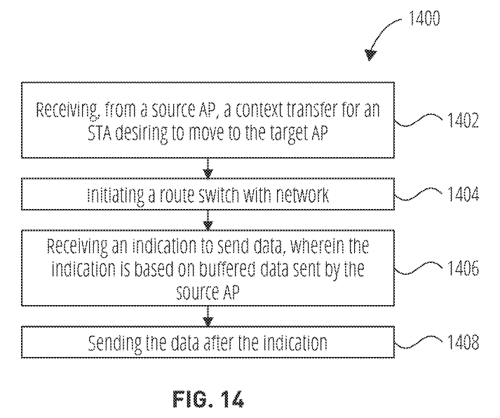

FIG. 14 illustrates a method 1400 for a target AP, according to embodiments herein. The illustrated method 1400 includes receiving 1402, from a source AP, a context transfer for an STA desiring to move to the target AP. The method 1400 further includes initiating 1404 a route switch with network. The method 1400 further includes receiving 1406 an indication to send data, wherein the indication is based on buffered data sent by the source AP. The method 1400 further includes sending 1408 the data after the indication.

In some embodiments of the method 1400, the indication indicates that the buffered data corresponding to all TIDs is retrieved by the STA.

In some embodiments of the method 1400, the indication indicates that buffered data corresponding to a specific TID is retrieved by the STA. In some such embodiments, the indication to send the data is sent by the source AP when the source AP has no further buffered downlink data for the TID, and wherein the method further comprises sending a frame to the STA indicating that the source AP has no further buffered downlink data for the TID.

In some embodiments of the method 1400, the data is sent using a common sequence number space between the source AP and the target AP. Some such embodiments further comprise sending to the STA a frame to move a window of the common sequence number space forward and to signal completion of downlink for the buffered data on the source AP. In certain such embodiments, the frame is a BAR frame. In certain other such embodiments, the frame comprises downlink data belonging to a TID with buffered data that has been sent by the source AP.

In some embodiments, the method 1400 further comprises receiving, from the STA, a request to wait for the indication to transmit data associated with a TID, wherein the indication to send data is sent by the STA. In some such embodiments, the indication is received either after completion of delivery of data from the source AP or a link with the source AP is lost.

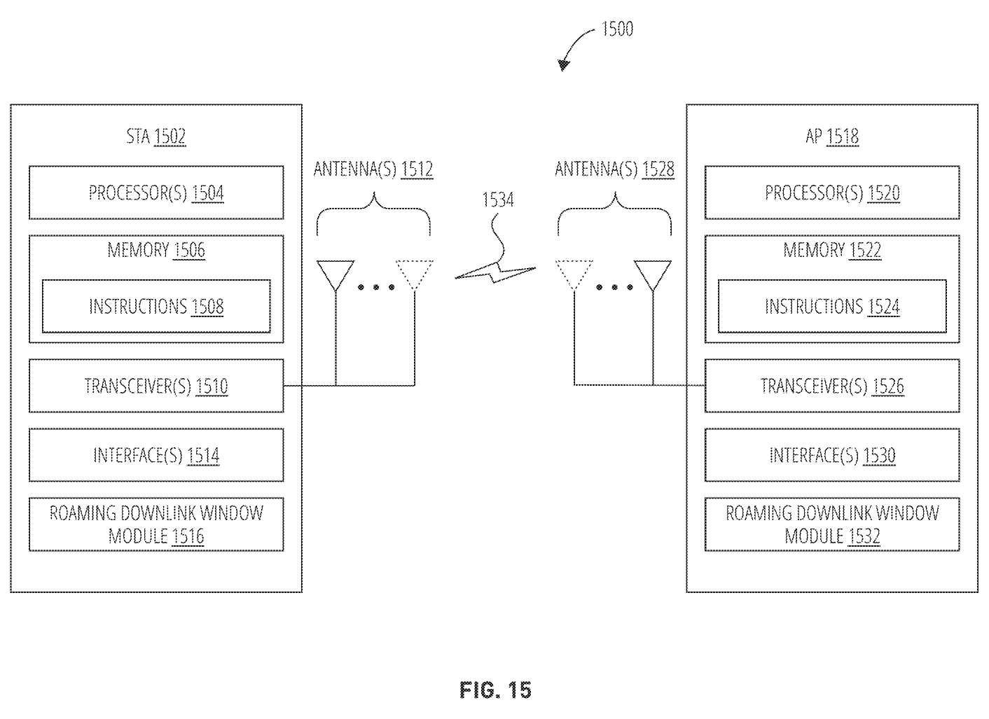

FIG. 15 illustrates a system 1500 for performing signaling 1534 between an STA 1502 and an AP 1518, according to embodiments disclosed herein. The system 1500 may be a portion of a wireless communications system as herein described. The STA 1502 may be, for example, a UE of a wireless communication system. The AP 1518 may be, for example, an access point of a wireless communication system.

The STA 1502 may include one or more processor(s) 1504. The processor(s) 1504 may execute instructions such that various operations of the STA 1502 are performed, as described herein. The processor(s) 1504 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The STA 1502 may include a memory 1506. The memory 1506 may be a non-transitory computer-readable storage medium that stores instructions 1508 (which may include, for example, the instructions being executed by the processor(s) 1504). The instructions 1508 may also be referred to as program code or a computer program. The memory 1506 may also store data used by, and results computed by, the processor(s) 1504.

The STA 1502 may include one or more transceiver(s) 1510 that may include radio frequency (RF) transmitter circuitry and/or receiver circuitry that use the antenna(s) 1512 of the STA 1502 to facilitate signaling (e.g., the signaling 1534) to and/or from the STA 1502 with other devices (e.g., the AP 1518).

The STA 1502 may include one or more antenna(s) 1512 (e.g., one, two, four, or more). For embodiments with multiple antenna(s) 1512, the STA 1502 may leverage the spatial diversity of such multiple antenna(s) 1512 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the STA 1502 may be accomplished according to precoding (or digital beamforming) that is applied at the STA 1502 that multiplexes the data streams across the antenna(s) 1512 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the STA 1502 may implement analog beamforming techniques, whereby phases of the signals sent by the antenna(s) 1512 are relatively adjusted such that the (joint) transmission of the antenna(s) 1512 can be directed (this is sometimes referred to as beam steering).

The STA 1502 may include one or more interface(s) 1514. The interface(s) 1514 may be used to provide input to or output from the STA 1502. For example, an STA 1502 that is a UE may include interface(s) 1514 such as microphones, speakers, a touchscreen, buttons, and the like to allow for input and/or output to the UE by a user of the UE. Other interfaces of such a UE may be made up of transmitters, receivers, and other circuitry (e.g., other than the transceiver(s) 1510/antenna(s) 1512 already described) that allow for communication between the UE and other devices and may operate according to known protocols (e.g., Wi-Fi^{®}, Bluetooth®, and the like).

The STA 1502 may include a roaming downlink window module 1516. The roaming downlink window module 1516 may be implemented via hardware, software, or combinations thereof. For example, the roaming downlink window module 1516 may be implemented as a processor, circuit, and/or instructions 1508 stored in the memory 1506 and executed by the processor(s) 1504. In some examples, the roaming downlink window module 1516 may be integrated within the processor(s) 1504 and/or the transceiver(s) 1510. For example, the roaming downlink window module 1516 may be implemented by a combination of software components (e.g., executed by a DSP or a general processor) and hardware components (e.g., logic gates and circuitry) within the processor(s) 1504 or the transceiver(s) 1510.

The roaming downlink window module 1516 may be used for various aspects of the present disclosure, for example, aspects of FIGS. 9-12.

The AP 1518 may include one or more processor(s) 1520. The processor(s) 1520 may execute instructions such that various operations of the AP 1518 are performed, as described herein. The processor(s) 1520 may include one or more baseband processors implemented using, for example, a CPU, a DSP, an ASIC, a controller, an FPGA device, another hardware device, a firmware device, or any combination thereof configured to perform the operations described herein.

The AP 1518 may include a memory 1522. The memory 1522 may be a non-transitory computer-readable storage medium that stores instructions 1524 (which may include, for example, the instructions being executed by the processor(s) 1520). The instructions 1524 may also be referred to as program code or a computer program. The memory 1522 may also store data used by, and results computed by, the processor(s) 1520.

The AP 1518 may include one or more transceiver(s) 1526 that may include RF transmitter circuitry and/or receiver circuitry that use the antenna(s) 1528 of the AP 1518 to facilitate signaling (e.g., the signaling 1534) to and/or from the AP 1518 with other devices (e.g., the STA 1502).

The AP 1518 may include one or more antenna(s) 1528 (e.g., one, two, four, or more). In embodiments having multiple antenna(s) 1528, the AP 1518 may perform MIMO, digital beamforming, analog beamforming, beam steering, etc., as has been described.

The AP 1518 may include one or more interface(s) 1530. The interface(s) 1530 may be used to provide input to or output from the AP 1518. For example, an AP 1518 that is a base station may include interface(s) 1530 made up of transmitters, receivers, and other circuitry (e.g., other than the transceiver(s) 1526/antenna(s) 1528 already described) that enables the base station to communicate with other equipment in a core network, and/or that enables the base station to communicate with external networks, computers, databases, and the like for purposes of operations, administration, and maintenance of the base station or other equipment operably connected thereto.

The AP 1518 may include a roaming downlink window module 1532. The roaming downlink window module 1532 may be implemented via hardware, software, or combinations thereof. For example, the roaming downlink window module 1532 may be implemented as a processor, circuit, and/or instructions 1524 stored in the memory 1522 and executed by the processor(s) 1520. In some examples, the roaming downlink window module 1532 may be integrated within the processor(s) 1520 and/or the transceiver(s) 1526. For example, the roaming downlink window module 1532 may be implemented by a combination of software components (e.g., executed by a DSP or a general processor) and hardware components (e.g., logic gates and circuitry) within the processor(s) 1520 or the transceiver(s) 1526.

The roaming downlink window module 1532 may be used for various aspects of the present disclosure, for example, aspects of FIGS. 9-11 and 13-14. The roaming downlink window module 1532 is configured to authenticate the STA 1502 and provide the STA 1502 with authentication credentials.

Embodiments contemplated herein include an apparatus comprising means to perform one or more elements of the method 1200. This apparatus may be, for example, an apparatus of a STA (such as STA 1502 as described herein).

Embodiments contemplated herein include one or more non-transitory computer-readable media comprising instructions to cause an electronic device, upon execution of the instructions by one or more processors of the electronic device, to perform one or more elements of the method 1200. This non-transitory computer-readable media may be, for example, a memory of a STA (such as a memory 1506 of an STA 1502, as described herein).

Embodiments contemplated herein include an apparatus comprising logic, modules, or circuitry to perform one or more elements of the method 1200. This apparatus may be, for example, an apparatus of a STA (such as an STA 1502, as described herein).

Embodiments contemplated herein include an apparatus comprising: one or more processors and one or more computer-readable media comprising instructions that, when executed by the one or more processors, cause the one or more processors to perform one or more elements of the method 1200. This apparatus may be, for example, an apparatus of a STA (such as an STA 1502, as described herein).

Embodiments contemplated herein include a signal as described in or related to one or more elements of the method 1200.

Embodiments contemplated herein include a computer program or computer program product comprising instructions, wherein execution of the program by a processor is to cause the processor to carry out one or more elements of the method 1200. The processor may be a processor of a STA (such as a processor(s) 1504 of an STA 1502, as described herein). These instructions may be, for example, located in the processor and/or on a memory of the STA (such as a memory 1506 of an STA 1502, as described herein).

Embodiments contemplated herein include an apparatus comprising means to perform one or more elements of the method 1300 and method 1400. This apparatus may be, for example, an apparatus of an AP (such as an AP 1518, as described herein).

Embodiments contemplated herein include one or more non-transitory computer-readable media comprising instructions to cause an electronic device, upon execution of the instructions by one or more processors of the electronic device, to perform one or more elements of the method 1300 and method 1400. This non-transitory computer-readable media may be, for example, a memory of an AP (such as a memory 1522 of an AP 1518, as described herein).

Embodiments contemplated herein include an apparatus comprising logic, modules, or circuitry to perform one or more elements of the method 1300 and method 1400. This apparatus may be, for example, an apparatus of an AP (such as an AP 1518, as described herein).

Embodiments contemplated herein include an apparatus comprising: one or more processors and one or more computer-readable media comprising instructions that, when executed by the one or more processors, cause the one or more processors to perform one or more elements of the method 1300 and method 1400. This apparatus may be, for example, an apparatus of an AP (such as an AP 1518, as described herein).

Embodiments contemplated herein include a signal as described in or related to one or more elements of the method 1300 and method 1400.

Embodiments contemplated herein include a computer program or computer program product comprising instructions, wherein execution of the program by a processing element is to cause the processing element to carry out one or more elements of the method 1300 and method 1400. The processor may be a processor of an AP (such as a processor(s) 1520 of an AP 1518, as described herein). These instructions may be, for example, located in the processor and/or on a memory of the AP (such as a memory 1522 of an AP 1518, as described herein).

For one or more embodiments, at least one of the components set forth in one or more of the preceding figures may be configured to perform one or more operations, techniques, processes, and/or methods as set forth herein. For example, a processor as described herein in connection with one or more of the preceding figures may be configured to operate in accordance with one or more of the examples set forth herein. For another example, circuitry associated with a STA or AP as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a station (STA), the method comprising:
sending a roaming initiation signal to a source access point (AP) to indicate to the source AP a desire to move to a target AP;
receiving a roam ready message from the source AP;
retrieving buffered data from the source AP after the roam ready message is received;
requesting the target AP to begin transmitting new data for at least one Traffic Identifier (TID); and
receiving the new data from the target AP.

2. The method of claim 1, wherein the buffered data from the source AP and the new data from the target AP are received concurrently.

3. The method of claim 1, wherein the new data from the target AP is sent after the buffered data from the source AP is retrieved.

4. The method of claim 3, wherein the new data is not sent until data corresponding to all the TIDs are retrieved from the buffered data.

5. The method of claim 1, wherein the buffered data from the source AP and the new data from the target AP are sequentially retrieved using a common sequence number space, wherein sequence number overlap is accounted for during sequential retrieval.

6. The method of claim 1, wherein the buffered data from the source AP and the new data from the target AP use non-contiguous sequence number spaces.

7. The method of claim 1, further comprising receiving an indication from the target AP when the source AP has no further buffered downlink data for a specific TID.

8. The method of claim 1, further comprising:
sending to the source AP a request for a per TID sequential operation;
maintaining an active link with both the source AP and the target AP after receiving the roam ready message; and
receiving a frame from the target AP indicating to move a window of a common sequence number space forward, and wherein the frame signals completion of downlink for a specific TID on the source AP.

9. The method of claim 8, wherein the frame from the target AP is a Block Acknowledgment Request (BAR) frame.

10. The method of claim 8, wherein the frame comprises downlink data belonging to the specific TID.

11. The method of claim 1, further comprising:
requesting that the target AP wait for an explicit signal from the STA to transmit data associated with each of the TIDs, and
sending the explicit signal to the target AP to request that the target AP move a window of a common sequence number space forward and transmit the new data.

12. The method of claim 11, further comprising receiving a notification of completion of data from the source AP for each of the TIDs.

13. The method of claim 11, wherein the explicit signal is sent in response to a link with the source AP being lost.

14. A method for a source access point (AP), the method comprising:
receiving, from a station (STA), a roaming initiation signal that indicates a desire to move to a target AP;
sending a roam ready message to the STA;
sending buffered data to the STA that was received after the roam ready message was sent, the buffered data corresponding to one or more Traffic Identifiers (TIDs); and
sending a notification of completion of delivery of the buffered data.

15. The method of claim 14, wherein the notification of completion of delivery of the buffered data is indicates data associated with a first TID of the one or more TIDs was sent.

16. The method of claim 15, further comprising continuing to send buffered data associated with other TIDs after the notification is sent.

17. The method of claim 15, wherein additional notifications of completion are sent for other TIDs as deliveries for the other TIDs are completed.

18. The method of claim 14, wherein the notification of completion of delivery of the buffered data is sent when the buffered data associated with all of the one or more TIDs are sent.

19. The method of claim 14, wherein the notification of completion is sent to the target AP.

20. The method of claim 14, further comprising receiving, from the STA, a request for a per TID sequential operation.
